(19) United States
(12) Patent Application Publication
(10) Pub. No.: US 2024/0346732 A1
(43) Pub. Date: Oct. 17, 2024

(54) METHOD AND APPARATUS FOR ADDING VIDEO EFFECT, AND DEVICE AND STORAGE MEDIUM

(71) Applicant: Beijing Zitiao Network Technology Co., Ltd., Beijing (CN)

(72) Inventor: Xiaoting LIANG, Beijing (CN)

(21) Appl. No.: 18/579,303

(22) PCT Filed: May 23, 2022
(86) PCT No.: PCT/CN2022/094362

§ 371 Date: Jan. 12, 2024

(30) Foreign Application Priority Data
Jul. 15, 2021 (CN) 202110802924.3

(51) Int. Cl. G06T 13/40; G06F 3/04817; G06T 3/40; G06T 7/20; G06T 7/70; G06T 15/00

(52) U.S. Cl. CPC G06T 13/40; G06F 3/04817; G06T 3/40; G06T 7/20; G06T 7/70; G06T 15/00; G06T 2207/30201

(57) ABSTRACT

A method and apparatus for adding a video effect, a device, and a storage medium are provided. The method includes: obtaining a moving instruction; controlling a moving path of an animated object in a video frame based on the moving instruction; determining an icon captured by the animated object on the video frame based on the moving path; and adding a video effect corresponding to the icon to the video frame. By adopting the solutions provided in the embodiments of the present disclosure, the video effect added to the video frame can be individually controlled based on the moving instruction.

### CROSS-REFERENCE TO RELATED APPLICATION

The present application claims priority of the Chinese Patent Application No. 202110802924.3 filed with China National Intellectual Property Administration on Jul. 15, 2021, and entitled “Method and Apparatus for Adding Video Effect, Device, and Storage Medium”, the entire disclosure of which is incorporated herein by reference as the present disclosure.

### TECHNICAL FIELD

Embodiments of the present disclosure relate to the technical field of video processing, and in particular, to a method and apparatus for adding a video effect, a device, and a storage medium.

### BACKGROUND

The video application provided by related technologies support adding special effects to the video. However, the related technologies provide merely a single effect adding method which involves less interaction with users and lacks interestingness. Therefore, how to improve the interestingness of a method for adding a video effect and enhance user experience is a technical problem urgently needing to be solved in the art.

### SUMMARY

To solve or solve at least in part the above-mentioned technical problem, embodiments of the present disclosure provide a method and apparatus for adding a video effect, a device, and a storage medium.

In a first aspect, embodiments of the present disclosure provide a method for adding a video effect, which includes:
obtaining a moving instruction;
controlling a moving path of an animated object in a video frame based on the moving instruction;
determining an icon captured by the animated object on the video frame based on the moving path; and
adding a video effect corresponding to the icon to the video frame.

Optionally, obtaining a moving instruction includes:

obtaining a posture of a control object; and
determining the corresponding moving instruction based on a correspondence between the posture and the moving instruction.

Optionally, the posture includes a deflecting direction of a head of the control object;
determining the corresponding moving instruction based on a correspondence between the posture and the moving instruction includes:
determining a moving direction of the animated object based on a correspondence between the deflecting direction of the head and the moving direction.

Optionally, determining an icon captured by the animated object on the video frame based on the moving path includes:
based on the moving path, determining an icon of which a distance from the moving path is less than a preset distance as the icon captured by the animated object.

Optionally, before adding a video effect corresponding to the icon to the video frame, further includes:
obtaining a facial image of the control object and displaying the facial image on the video frame; or displaying a virtual facial image obtained based on processing of the facial image of the control object on the video frame; or displaying a facial image of the animated object on the video frame; and
adding a video effect corresponding to the icon to the video frame includes:
adding the video effect corresponding to the icon to the facial image displayed on the video frame.

Optionally, the video effect corresponding to the icon includes a makeup effect or a beauty effect; and
adding the video effect corresponding to the icon to the facial image displayed on the video frame includes:
adding the makeup effect or the beauty effect corresponding to the icon to the facial image.

Optionally, adding the makeup effect corresponding to the icon to the facial image includes:
in response to the facial image already including the makeup effect corresponding to the icon, deepening the color of the makeup effect.

Optionally, the video effect corresponding to the icon includes an animation effect of the animated object; and
adding a video effect corresponding to the icon to the video frame includes:
adding the animation effect corresponding to the icon to the animated object.

Optionally, the method further includes:
counting a video playing time; and
enlarging and displaying the facial image added with the effect in response to the counted time reaching a preset threshold.

In a second aspect, embodiments of the present disclosure provide an apparatus for adding a video effect, which includes:
a moving instruction obtaining unit configured to obtain a moving instruction;
a path determining unit configured to control a moving path of an animated object in a video frame based on the moving instruction;
an icon capturing unit configured to determine an icon captured by the animated object on the video frame based on the moving path; and
an effect adding unit configured to add a video effect corresponding to the icon to the video frame.

Optionally, the moving instruction obtaining unit includes:
a posture obtaining subunit configured to obtain a posture of a control object; and
a moving instruction obtaining subunit configured to determine the corresponding moving instruction based on a correspondence between the posture and the moving instruction.

Optionally, the posture includes a deflecting direction of the head of the control object; and
the moving instruction obtaining subunit is specifically configured to determine a moving direction of the animated object based on a correspondence between the deflecting direction of the head and the moving direction.

Optionally, the icon capturing unit is specifically configured to, based on the moving path, determine an icon to which a distance from the moving path is less than a preset distance as the icon captured by the animated object.

Optionally, the apparatus further includes a facial image adding unit configured to obtain a facial image of the control object and display the facial image on the video frame, or configured to display a virtual facial image obtained based on processing of the facial image of the control object on the video frame, or configured to display a facial image of the animated object on the video frame,
the effect adding unit is specifically configured to add the video effect corresponding to the icon to the facial image displayed on the video frame.

Optionally, the video effect corresponding to the icon includes a makeup effect or a beauty effect; and
the effect adding unit is specifically configured to add the makeup effect or the beauty effect corresponding to the icon to the facial image.

Optionally, the effect adding unit, upon performing the operation of adding the makeup effect corresponding to the icon to the facial image, is specifically configured to:
upon the facial image already including the makeup effect corresponding to the icon, deepen a color of the makeup effect.

Optionally, the video effect corresponding to the icon includes an animation effect of the animated object; and
the effect adding unit is specifically configured to add the animation effect corresponding to the icon to the animated object.

Optionally, the apparatus further includes:
a time counting unit configured to count a video playing time; and
an enlarging display unit configured to enlarge and display the facial image added with the effect in response to the counted time reaching a preset threshold.

In a third aspect, embodiments of the present disclosure provide a terminal device, the terminal device includes a memory and a processor, the memory stores a computer program; and the computer program upon being executed by the processor, implements the method of the first aspect.

In a fourth aspect, embodiments of the present disclosure provide a computer-readable storage medium, which stores a computer program, the computer program upon being executed by a processor, implements the method of the first aspect.

In a fifth aspect, embodiments of the present disclosure provide a computer program product, which includes a computer program carried on a computer-readable storage medium, the computer program includes a program code for implementing the method of the first aspect.

Compared with the related art, the technical solutions provided in the embodiments of the present disclosure have the following advantages:

According to the embodiments of the present disclosure, a moving instruction is obtained; a moving path of an animated object in a video frame is controlled based on the moving instruction to control a particular icon captured by the animated object; and a video effect corresponding to the particular icon is added to the video frame. In other words, by adopting the solutions provided in the embodiments of the present disclosure, the video effect added to the video frame can be individually controlled based on the moving instruction. Thus, the individuation and interestingness of video effect addition are improved, and the user experience is enhanced.

### BRIEF DESCRIPTION OF THE DRAWINGS

The accompanying drawings, which are hereby incorporated in and constitute a part of the present description, illustrate embodiments of the present disclosure, and together with the description, serve to explain the principles of the present disclosure.

To explain the technical solutions in the embodiments of the present disclosure or in the prior art more clearly, the accompanying drawings required for describing the embodiments or the prior art will be briefly described below. Apparently, a person of ordinary skill in the art can derive other drawings from these accompanying drawings without creative work.

FIG. 1 is a flowchart of a method for adding a video effect provided in an embodiment of the present disclosure;

FIG. 2 is a schematic diagram of a terminal device provided in an embodiment of the present disclosure;

FIG. 3 is a schematic diagram of obtaining a moving instruction in some embodiments of the present disclosure;

FIG. 4 is a schematic diagram of a position of an animated object at a current time point in some embodiments of the present disclosure;

FIG. 5 is a schematic diagram of a position of an animated object at next time point in some embodiments of the present disclosure;

FIG. 6 is a schematic diagram of determining an icon captured by an animated object in some embodiments of the present disclosure;

FIG. 7 is a schematic diagram of determining an icon captured by an animation in some other embodiments of the present disclosure;

FIG. 8 is a flowchart of a method for adding a video effect provided in another embodiment of the present disclosure;

FIG. 9 is a schematic diagram of a video frame displayed in some embodiments of the present disclosure;

FIG. 10 is a schematic diagram of a video frame displayed in some embodiments of the present disclosure;

FIG. 11 is a schematic diagram of a video frame displayed in some embodiments of the present disclosure;

FIG. 12 is a structural schematic diagram of an apparatus for adding a video effect provided in an embodiment of the present disclosure; and

FIG. 13 is a structural schematic diagram of a terminal device in an embodiment of the present disclosure.

### DETAILED DESCRIPTION

To provide a clearer understanding of the objectives, features, and advantages of the embodiments of the present disclosure, the solutions in the embodiments of the present disclosure will be further described below. It should be noted that the embodiments in the present disclosure and features in the embodiments may be combined with one another without conflict.

Many specific details are described below to help fully understand the embodiments of the present disclosure. However, the embodiments of the present disclosure may also be implemented in other manners different from those described herein. Apparently, the described embodiments in the specification are merely some rather than all of the embodiments of the present disclosure.

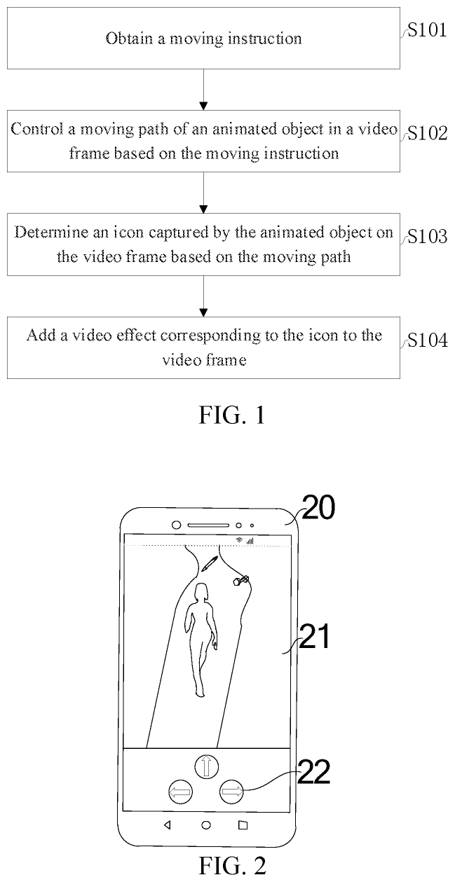

FIG. 1 is a flowchart of a method for adding a video effect provided in an embodiment of the present disclosure. The method may be performed by a terminal device. The terminal device may be exemplarily construed as a device capable of video processing and video playing, such as a smart phone, a tablet computer, a laptop computer, a desktop computer, a smart television, and the like. As shown in FIG. 1, the method for adding a video effect provided in the embodiment of the present disclosure includes steps S101 to S104.

Step S101: obtaining a moving instruction.

In an embodiment of the present disclosure, the moving instruction may be construed as an instruction for controlling a moving direction or a moving way of an animated object in a video frame. The moving instruction may be obtained in at least one manner. For example, in some embodiments of the present disclosure, the terminal device may be equipped with a microphone. The terminal device may acquire a speech signal corresponding to a control object by means of the microphone, and analyze and process the speech signal based on a preset speech analysis model to obtain the moving instruction corresponding to the speech signal. The control object refers to an object for triggering the terminal device to generate or obtain the corresponding moving instruction. For another example, in some other embodiments of the present disclosure, the moving instruction may also be obtained by means of a preset key (including a virtual key and a real key). As a matter of course, this is an example of the manner of obtaining the moving instruction and not a limitation thereto. In practice, the manner and method of obtaining the moving instruction may be set as needed. For example, FIG. 2 is a schematic diagram of an interface of a terminal device provided in some embodiments of the present disclosure. As shown in FIG. 2, in some other embodiments of the present disclosure, the terminal device 20 may be further equipped with a touch display screen 21 on which a direction control key 22 is displayed. The terminal device may determine the corresponding moving instruction by detecting the triggered direction control key 22. For another example, in some other embodiments of the present disclosure, the terminal device may be further equipped with an auxiliary control device (e.g., a joystick, but not limited thereto). The terminal device may obtain the corresponding moving instruction by receiving a control signal from the auxiliary control device. For another example, in some embodiments of the present disclosure, the terminal device may also determine the corresponding moving instruction based on a posture of the control object by using the method of steps S1011 to S1012.

Steps S1011: obtaining a posture of a control object.

Step S1012: determining the corresponding moving instruction based on a correspondence between the posture and the moving instruction.

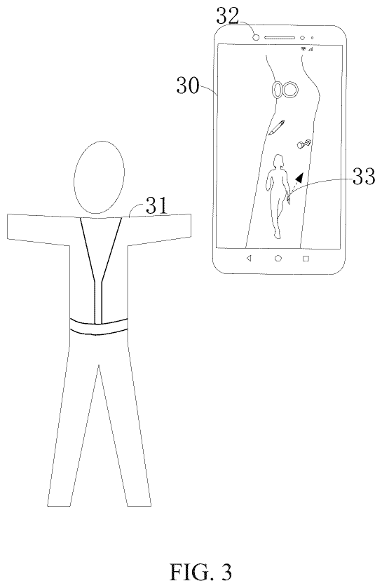

In the implementation of determining the moving instruction based on the posture of the control object, the terminal device is equipped with a shooting apparatus and stores correspondences between various postures and corresponding moving instructions. The terminal device shoots an image of the control object by means of the shooting apparatus and identifies (e.g., by using a deep learning method, but not limited thereto) movements of limbs and trunk (including the head and the four limbs) of the control object based on a preset identification algorithm or model to obtain the posture of the control object in the image, and then may obtain the corresponding moving instruction by searching in the prestored correspondences according to the determined posture. For example, FIG. 3 is a schematic diagram of a method of obtaining a moving instruction in some embodiments of the present disclosure. As shown in FIG. 3, in some embodiments, the terminal device 30 may determine the corresponding moving instruction according to the deflecting direction of the head by identifying a deflecting direction of a head of the control object 31. Specifically, after the shooting apparatus 32 in the terminal device 30 shoots the image of the control object 31, the deflecting direction of the head of the control object 31 is identified.

The terminal device 30 may prestore a correspondence between a deflecting direction of the head and a moving direction of the animated object. The terminal device 30 may determine the corresponding instruction for controlling the moving direction of the animated object 33 according to the correspondence after identifying the deflecting direction of the head of the control object 31 from the image of the control object 31.

As can be seen from FIG. 3, the head of the control object 31 deflects rightwards, and the corresponding moving direction is moving toward the right front in the video frame (i.e., the direction indicated by the arrow in FIG. 3). It should be noted that FIG. 3 shows merely an example and is non-limiting. In addition, the arrow in the video frame in FIG. 3 is merely an example representation, and the arrow for indicating the direction may not be displayed in practical use.

Step S102, controlling a moving path of an animated object in a video frame based on the moving instruction.

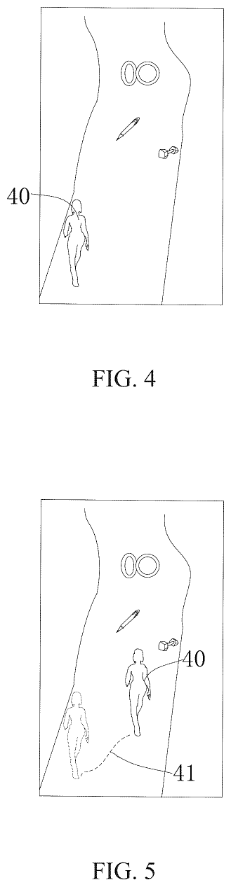

For example, FIG. 4 is a schematic diagram of a position of the animated object at a first time point in some embodiments of the present disclosure and FIG. 5 is a schematic diagram of a position of the animated object at a second time point in some embodiments of the present disclosure. As shown in FIG. 4 and FIG. 5, at the time point corresponding to FIG. 4, the terminal device obtains a moving instruction of moving rightwards, and the animated object 40 will move rightwards under the control of the terminal device to obtain the moving path 41 shown in FIG. 5 (the trajectory of the dotted line in FIG. 5). As a matter of course, this is merely an example and is non-limiting.

Step S103: determining an icon captured by the animated object on the video frame based on the moving path.

In an embodiment of the present disclosure, a plurality of icons are scattered on the video frame, and the position coordinate of each icon in the video frame has been determined.

After the moving path of the animated object is determined, icons in the moving path of the animated object may be determined according to the moving path and the position coordinates of each icon in the animated object.

In an embodiment of the present disclosure, an icon in the moving path may be construed as an icon of which a distance from the moving path is less than a preset distance on the video frame or an icon of which coordinates coincide with a point in the moving path.

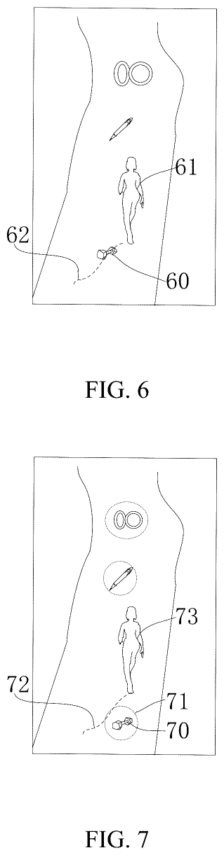

FIG. 6 is a schematic diagram of determining an icon captured by the animated object in some embodiments of the present disclosure. As shown in FIG. 6, in some embodiments, the coordinates of the icon 60 are located in the moving path 62 of the animated object 61, and the icon 60 is the icon captured by the animated object 61.

FIG. 7 is a schematic diagram of determining an icon captured by the animated object in some other embodiments of the present disclosure. As shown in FIG. 7, in some other embodiments, each icon 70 has an action range 71 with the coordinates of the icon 70 as a center and a preset distance as a radius. If the action range of an icon and the moving path 72 intersect, the icon is regarded as the icon captured by the animated object 73.

As a matter of course, FIG. 6 and FIG. 7 show merely examples and are non-limiting.

Step S104: adding a video effect corresponding to the icon to the video frame.

In an embodiment of the present disclosure, an icon of each type corresponds to a video effect. If an icon is captured by the animated object, the video effect corresponding to the icon is added to the video frame and displayed.

According to the embodiments of the present disclosure, a moving instruction is obtained; a moving path of an animated object in a video frame is controlled based on the moving instruction to control a particular icon captured by the animated object; and a video effect corresponding to the particular icon is added to the video frame. In other words, by adopting the solutions provided in the embodiments of the present disclosure, the video effect added to the video frame can be individually controlled based on the moving instruction. Thus, the individuation and interestingness of video effect addition are improved, and the user experience is enhanced.

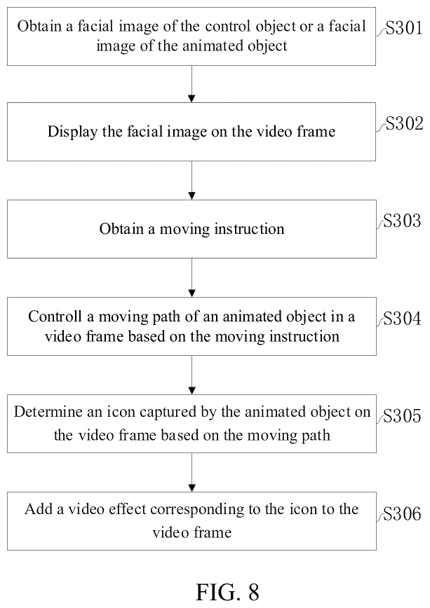

FIG. 8 is a flowchart of a method for adding a video effect provided in another embodiment of the present disclosure. As shown in FIG. 8, in some other embodiments of the present disclosure, the method for adding a video effect includes steps S301 to S306.

Step S301: obtaining a facial image of the control object or a facial image of the animated object.

In some embodiments of the present disclosure, the facial image of the control object may be obtained in a first preset manner. The first preset manner may include at least a shooting manner and a manner of loading from a memory.

The shooting manner refers to obtaining the facial object of the control object by photographing the control object using a shooting apparatus provided in a terminal device. The manner of loading from the memory refers to loading the facial object of the control object from the memory of the terminal device. It will be understood that the first preset manner is not limited to the above-mentioned shooting manner and the manner of loading from the memory and may also be other manners in the art.

The facial image of the animated object may be extracted from a video material.

Step S302: displaying the facial image on the video frame.

After the facial image of the control object is obtained, the facial image may be loaded to a particular display region of the video frame to realize display and output of the facial image.

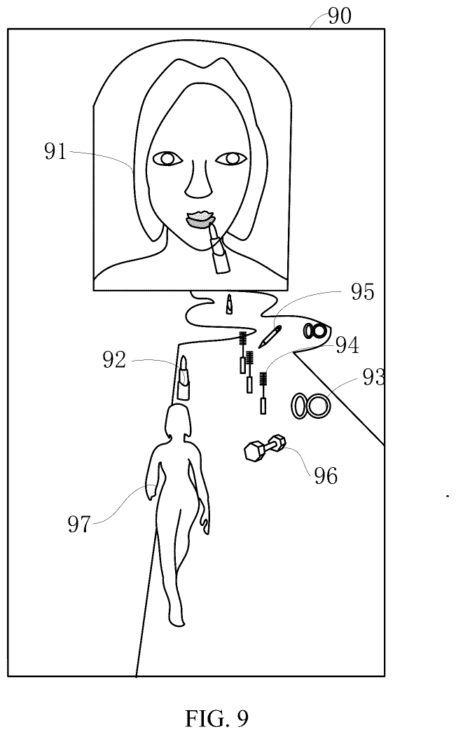

For example, FIG. 9 is a schematic diagram of a video frame displayed in some embodiments of the present disclosure. As shown in FIG. 9, in some video frames 90 displayed in the embodiments of the present disclosure, the facial image 91 of the control object may be displayed in upper regions of the video frames.

Step S303: obtaining a moving instruction.

Step S304, controlling a moving path of an animated object in a video frame based on the moving instruction.

Step S305: determining an icon captured by the animated object on the video frame based on the moving path.

Specific implementation processes of steps S303 to S305 may be the same with the foregoing steps S101 to S103. Steps S303 to S305 may be explained with reference to the explanations of steps S101 to S103, which will not be redundantly described herein.

Step S306: adding a video effect corresponding to the icon to the video frame.

In some embodiments of the present disclosure, an icon of each type corresponds to a video effect. If an icon is captured by the animated object, the video effect corresponding to the icon is added to the facial image. For example, FIG. 9 includes makeup icons such as a lipstick icon 92, a liquid foundation icon 93, a mascara cream icon 94, and an eyebrow pencil icon 95, and icons for representing beauty processing, such as a dumbbell icon 96. The video effect corresponding to the lipstick icon 92 includes applying lipstick to the lips in the facial image. The video effect corresponding to the liquid foundation icon 93 includes applying foundation to the face in the facial image. The video effect corresponding to the mascara cream icon 94 includes coloring eyelashes in the facial image and adding eyeshadow to the facial image. The video effect corresponding to the eyebrow pencil icon 95 includes blackening the eyebrow regions in the facial image. The video effect corresponding to the dumbbell icon 96 including performing face thinning on the facial image. If the above-mentioned makeup icon or beauty icon is captured by the animated object, the corresponding makeup effect or beauty effect is applied to the facial image such that the facial image is modified. For example, the lipstick icon 92 is captured by the animated object 97, the operation of applying lipstick to the lips in the facial image is displayed in the video frame such that lipstick is applied to the lips. In other words, in some embodiments of the present disclosure, the video effect corresponds to the icon may include the makeup effect or the beauty effect. If the corresponding icon is located in the moving path of the animated object and captured by the animated object, the makeup effect or the beauty effect corresponding to the icon may be added to the facial image in step S306.

In other embodiments of the present disclosure, the video effect corresponding to the icon displayed in the video frame may also be other video effects, which will not be particularly limited herein.

By the above-mentioned steps S301 to S306, the interestingness of the video effect adding method can be improved by displaying the facial image of the control object or the facial image of the animated object on the video frame and adding the video effect corresponding to the icon captured by the animated object to the facial image.

It needs to be noted that: in other implementations of the present disclosure, the obtained facial image of the control object may also be processed to obtain a virtual facial image corresponding to the control object, and the virtual facial image corresponding to the control object is displayed on the video frame such that the video effect corresponding to the icon is added to the virtual facial image.

In some embodiments of the present disclosure, in the video playing process, the animated object may successively capture a plurality of makeup icons of a same type, e.g., capture a plurality of lipstick icons. After a preceding icon is captured, the corresponding makeup effect is added to the facial image. In this case, step S3061 may include: in response to the facial image already including the makeup effect corresponding to the icon, deepening a color of the makeup effect.

In other words, in some embodiments of the present disclosure, in the case of already adding the makeup effect corresponding to a makeup icon to the facial image, if the animated object captures the makeup icon again, the corresponding makeup effect will be superimposed with the makeup effect already added to the facial image such that the makeup degree of the facial image is deepened. Thus, the types of the video effects applied to the facial image may be increased, thereby further improving the interestingness of the video effect adding process.

In some embodiments of the present disclosure, the video effect may include an animation effect for the animated object. In this case, the animation effect corresponding to the icon may also be added to the animated object.

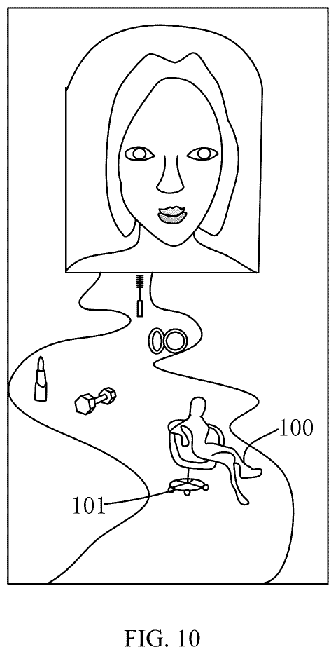

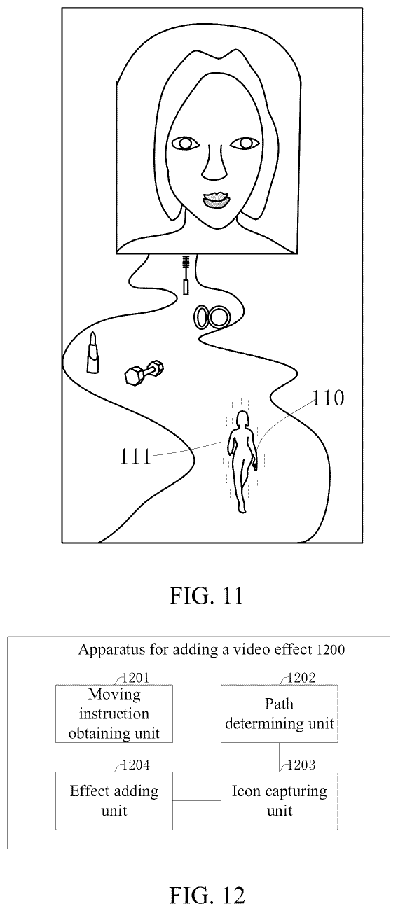

For example, in some embodiments of the present disclosure, the animation effects corresponding to some icons may be an animation effect of changing a moving speed or a moving way of the animated object. After the animated object captures the icon, the animation effect corresponding to the icon is added to the animated object to change the moving speed or the moving way of the animated object. For example, FIG. 10 is a schematic diagram of a video frame displayed in some embodiments of the present disclosure. As shown in FIG. 10, in some embodiments of the present disclosure, after the animated object 100 captures an icon, if the animation effect for the animated object 100 included in the icon is an animation effect of sitting in an office chair 101, the animated object 100 sits in the office chair 101 and rapidly slides forward. By changing the moving speed or the moving way of the animated object, the difficulty of controlling the animated object to capture other icons may be changed, and the interestingness of controlling the animated object to move may be further improved. For another example, in some embodiments of the present disclosure, the video effect corresponding to the icon may also include an animation effect for the animated object. FIG. 11 is a schematic diagram of a video frame displayed in some embodiments of the present disclosure. As shown in FIG. 11, in some embodiments of the present disclosure, after the animated object 110 captures an icon, a shining cursor 111 is formed around the animated object 110, and the shining cursor 11 is added around the animated object 110 to display that the icon is captured.

After the animated object captures the icon, the animation effect that the corresponding icon is captured is added to the animated object. By displaying the animation effect that the icon has been captured, it may be prompted which icons have been captured to improve the interactivity of video playing.

In some embodiments of the present disclosure, the method for adding a video effect may include steps S308 and to S309 in addition to the foregoing steps S301 to S306.

Step S308: counting a video playing time.

Step S309: enlarging and displaying the facial image added with the effect in response to the counted time reaching a preset threshold.

In an embodiment of the present disclosure, when playing is started or the moving instruction from the control object is detected, the video playing time is counted, and whether the counted time is greater than a set threshold is determined. If the counted time reaches the set threshold, adding the video effect to the facial image is stopped, and the facial image added with the effect is amplified and displayed. By enlarging and displaying the facial image added with the effect, the facial image added with the effect may be displayed clearly.

FIG. 12 is a structural schematic diagram of an apparatus for adding a video effect provided in an embodiment of the present disclosure. The apparatus for adding a video effect may be construed as the above-mentioned terminal device or part of functional modules in the above-mentioned terminal device. As shown in FIG. 12, the apparatus 1200 for adding a video effect includes a moving instruction obtaining unit 1201, a path determining unit 1202, an icon capturing unit 1203, and an effect adding unit 1204.

The moving instruction obtaining unit 1201 is configured to obtain a moving instruction. The path determining unit 1202 is configured to control a moving path of an animated object in a video frame based on the moving instruction. The icon capturing unit 1203 is configured to determine an icon captured by the animated object on the video frame based on the moving path. The effect adding unit 1204 is configured to add a video effect corresponding to the icon to the video frame.

In some embodiments of the present disclosure, the instruction obtaining unit includes a posture obtaining subunit and a moving instruction obtaining subunit. The posture obtaining subunit is configured to obtain a posture of a control object. The moving instruction obtaining subunit is configured to determine the corresponding moving instruction based on a correspondence between the posture and the moving instruction.

In some embodiments of the present disclosure, the posture includes a deflecting direction of a head of the control object; and the moving instruction obtaining subunit is specifically configured to determine a direction of the animated object based on a correspondence between the deflecting direction of the head and the moving direction.

In some embodiments of the present disclosure, the icon capturing unit 1203 is specifically configured to, based on the moving path, determine an icon to which a distance from the moving path is less than a preset distance as the icon captured by the animated object.

In some embodiments of the present disclosure, the apparatus 1200 for adding a video effect further includes a facial image adding unit. The facial image adding unit is configured to obtain a facial image of the control object and display the facial image on the video frame, or configured to display a virtual facial image obtained based on processing of the facial image of the control object on the video frame, or configured to display a facial image of the animated object on the video frame. Correspondingly, the effect adding unit 1204 is specifically configured to add the video effect corresponding to the icon to the facial image displayed on the video frame.

In some embodiments of the present disclosure, the video effect corresponding to the icon includes a makeup effect or a beauty effect; and the effect adding unit 1204 is specifically configured to add the makeup effect or the beauty effect corresponding to the icon to the facial image.

In some embodiments of the present disclosure, the effect adding unit 1204, when performing the operation of adding the makeup effect corresponding to the icon to the facial image, is specifically configured to: when the facial image already has the makeup effect corresponding to the icon, deepen a color of the makeup effect.

In some embodiments of the present disclosure, the video effect corresponding to the icon includes an animation effect of the animated object; and the effect adding unit 1204 is specifically configured to add the animation effect corresponding to the icon to the animated object.

In some embodiments of the present disclosure, the apparatus 1200 for adding a video effect further includes a time counting unit and an enlarging display unit. The time counting unit is configured to count a video playing time. The enlarging display unit is configured to enlarge and display the facial image added with the effect in response to the counted time reaching a preset threshold.

The apparatus provided in the present embodiment is capable of performing the method for adding a video effect provided in any method embodiment described above, and the implementation manner and the beneficial effects are similar, which will not be described here redundantly.

An embodiment of the present disclosure further provides a terminal device, including a processor and a memory, the memory stores a computer program; and when the computer program is executed by the processor, the method for adding a video effect provided in any method embodiment described above may be implemented.

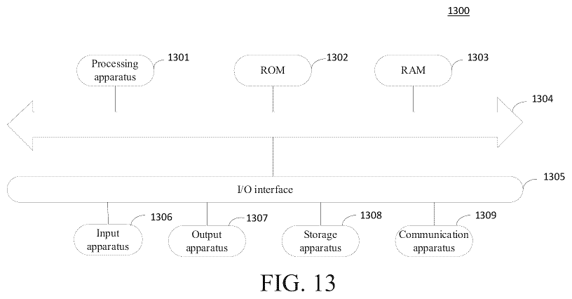

Exemplarily, FIG. 13 is a structural schematic diagram of a terminal device in an embodiment of the present disclosure. Specially, FIG. 13 illustrates a structural schematic diagram adapted to implement the terminal device 1300 in the embodiment of the present disclosure. The terminal device 1300 in the embodiment of the present disclosure may include but not be limited to mobile terminals such as a mobile phone, a notebook computer, a digital broadcasting receiver, a personal digital assistant (PDA), a portable Android device (PAD), a portable media player (PMP), and a vehicle-mounted terminal (e.g., a vehicle-mounted navigation terminal), and fixed terminals such as a digital TV and a desktop computer. The terminal device shown in FIG. 13 is merely an example, and should not pose any limitation to the functions and the range of use of the embodiments of the present disclosure.

As shown in FIG. 13, the terminal device 1300 may include a processing apparatus (e.g., a central processing unit, a graphics processing unit) 1301, which can perform various suitable actions and processing according to a program stored on the read-only memory (ROM) 1302 or a program loaded from the storage apparatus 1308 into the random-access memory (RAM) 1303. On the RAM 1303, various programs and data required by operations of the terminal device 1300 are also stored. The processing apparatus 1301, the ROM 1302, and the RAM 1303 are interconnected by means of a bus 1304. An input/output (I/O) interface 1305 is also connected to the bus 1304.

Usually, the following apparatuses may be connected to the I/O interface 1305: an input apparatus 1306 including, for example, a touch screen, a touch pad, a keyboard, a mouse, a camera, a microphone, an accelerometer, and a gyroscope; an output apparatus 1307 including, for example, a liquid crystal display (LCD), a loudspeaker, and a vibrator; a storage apparatus 1308 including, for example, a magnetic tape and a hard disk; and a communication apparatus 1309. The communication apparatus 1309 may allow the terminal device 1300 is to be in wireless or wired communication with other devices to exchange data. Although FIG. 13 illustrates the terminal device 1300 having various apparatuses, it is to be understood that all the illustrated apparatuses are not necessarily implemented or included. More or less apparatuses may be implemented or included alternatively.

Particularly, according to the embodiments of the present disclosure, the process described above with reference to the flowchart may be implemented as a computer software program. For example, an embodiment of the present disclosure includes a computer program product, which includes a computer program carried by a non-transitory computer-readable medium. The computer program includes a program code for performing the method shown in the flowchart. In such an embodiment, the computer program may be downloaded online through the communication apparatus 1309 and installed, or installed from the storage apparatus 1308, or installed from the ROM 1302. When the computer program is executed by the processing apparatus 1301, the functions defined in the method of the embodiments of the present disclosure are executed.

It needs to be noted that the computer-readable medium described above in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination of them. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In an embodiment of the present disclosure, the computer-readable storage medium may be any tangible medium containing or storing a program that can be used by or in combination with an instruction execution system, apparatus or device. In an embodiment of the present disclosure, the computer-readable signal medium may include a data signal that propagates in a baseband or as a part of a carrier and carries thereon a computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable storage medium may send, propagate or transmit a program used by or in combination with an instruction execution system, apparatus or device. The program code included on the computer-readable medium may be transmitted by using any suitable medium, including but not limited to an electric wire, a fiber-optic cable, radio frequency (RF) and the like, or any appropriate combination thereof.

In some implementations, a client and a server may communicate by means of any network protocol currently known or to be developed in future such as Hypertext Transfer Protocol (HTTP), and may achieve communication and interconnection with digital data (e.g., a communication network) in any form or of any medium. Examples of the communication network include a local area network (LAN), a wide area network (WAN), an internet work (e.g., the Internet), a peer-to-peer network (e.g., ad hoc peer-to-peer network), and any network currently known or to be developed in future.

The above-mentioned computer-readable medium may be included in the terminal device described above, or may exist alone without being assembled with the terminal device.

The above-mentioned computer-readable medium carries one or more programs. When the one or more programs are executed by the terminal device, the terminal device is caused to: obtain a moving instruction; control a moving path of an animated object in a video frame based on the moving instruction; determine an icon captured by the animated object on the video frame based on the moving path; and add a video effect corresponding to the icon to the video frame.

A computer program code for performing the operations in the embodiments of the present disclosure may be written in one or more programming languages or a combination thereof. The programming languages include but are not limited to object-oriented programming languages, such as Java, Smalltalk, and C++, and conventional procedural programming languages, such as C or similar programming languages. The program code can be executed fully on a user's computer, executed partially on a user's computer, executed as an independent software package, executed partially on a user's computer and partially on a remote computer, or executed fully on a remote computer or a server. In a circumstance in which a remote computer is involved, the remote computer may be connected to a user computer via any type of network, including a local area network (LAN) or a wide area network (WAN), or may be connected to an external computer (for example, connected via the Internet by using an Internet service provider).

The flowcharts and block diagrams in the accompanying drawings illustrate system architectures, functions and operations that may be implemented by the system, method and computer program product according to the embodiments of the present disclosure. In this regard, each block in the flowcharts or block diagrams may represent a module, a program segment or a part of code, and the module, the program segment or the part of code includes one or more executable instructions for implementing specified logic functions. It should also be noted that in some alternative implementations, functions marked in the blocks may also take place in an order different from the order designated in the accompanying drawings. For example, two consecutive blocks can actually be executed substantially in parallel, and they may sometimes be executed in a reverse order, which depends on involved functions. It should also be noted that each block in the flowcharts and/or block diagrams and combinations of the blocks in the flowcharts and/or block diagrams may be implemented by a dedicated hardware-based system for executing specified functions or operations, or may be implemented by a combination of dedicated hardware and computer instructions.

Related units described in the embodiments of the present disclosure may be implemented by software, or may be implemented by hardware. The name of a unit does not constitute a limitation on the unit itself.

The functions described above herein may be performed at least in part by one or more hardware logic components. For example, exemplary types of hardware logic components that can be used without limitations include a field programmable gate array (FPGA), an application specific integrated circuit (ASIC), an application specific standard product (ASSP), a system on chip (SOC), a complex programmable logic device (CPLD), and the like.

In the context of the embodiments of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include but be not limited to an electronic, magnetic, optical, electromagnetic, infrared, or semiconductor system, apparatus or device, or any appropriate combination thereof. More specific examples of the machine-readable storage medium may include an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination thereof.

An embodiment of the present disclosure further provides a computer-readable storage medium. The storage medium stores a computer program. When the computer program is executed by the processor, the method in any of the embodiments shown in FIG. 1 to FIG. 11 can be implemented, and the implementation manner and the beneficial effects are similar, which will not be described here redundantly.

It should be noted that relational terms herein such as “first” and “second” are only used to distinguish one entity or operation from another entity or operation without necessarily requiring or implying any actual such relationship or order between such entities or operations. In addition, terms “include”, “comprise”, or any other variations thereof are intended to cover non-exclusive including, so that a process, a method, an article, or a device including a series of elements not only includes those elements, but also includes other elements that are not explicitly listed, or also includes inherent elements of the process, the method, the article, or the device. Without more restrictions, the elements defined by the sentence “including a . . . ” do not exclude the existence of other identical elements in the process, method, article, or device including the elements.

The foregoing are descriptions of specific implementations of the present disclosure, allowing a person skilled in the art to understand or implement the embodiments of the present disclosure. A plurality of amendments to these embodiments are apparent to those skilled in the art, and general principles defined herein can be achieved in other embodiments without departing from the spirit or scope of the embodiments of the present disclosure. Thus, the embodiments of the present disclosure will not be limited to these embodiments described herein, but shall accord with the widest scope consistent with the principles and novel characteristics disclosed herein.

What is claimed is:

1. A method for adding a video effect, comprising:
obtaining a moving instruction;
controlling a moving path of an animated object in a video frame based on the moving instruction;
determining an icon captured by the animated object on the video frame based on the moving path; and
adding the video effect corresponding to the icon to the video frame.

2. The method according to claim 1, wherein the obtaining a moving instruction comprises:
obtaining a posture of a control object; and
determining the corresponding moving instruction based on a correspondence between the posture and the moving instruction.

3. The method according to claim 2, wherein the posture comprises a deflecting direction of a head of the control object; and
the determining the corresponding moving instruction based on a correspondence between the posture and the moving instruction comprises:
determining a moving direction of the animated object based on a correspondence between the deflecting direction of the head and the moving direction.

4. The method according to claim 1, wherein the determining an icon captured by the animated object on the video frame based on the moving path comprises:
based on the moving path, determining an icon to which a distance from the moving path is less than a preset distance as the icon captured by the animated object.

5. The method according to claim 1, before the adding a video effect corresponding to the icon to the video frame, further comprising:
obtaining a facial image of the control object and displaying the facial image on the video frame; or displaying a virtual facial image obtained based on processing of the facial image of the control object on the video frame; or displaying a facial image of the animated object on the video frame; and
the adding a video effect corresponding to the icon to the video frame comprises:
adding the video effect corresponding to the icon to the facial image displayed on the video frame.

6. The method according to claim 5, wherein the video effect corresponding to the icon comprises a makeup effect or a beauty effect; and
the adding the video effect corresponding to the icon to the facial image displayed on the video frame comprises:
adding the makeup effect or the beauty effect corresponding to the icon to the facial image.

7. The method according to claim 6, wherein the adding the makeup effect corresponding to the icon to the facial image comprises:
in response to the facial image already comprising the makeup effect corresponding to the icon, deepening a color of the makeup effect.

8. The method according to claim 1, wherein the video effect corresponding to the icon comprises an animation effect of the animated object; and
the adding a video effect corresponding to the icon to the video frame comprises:
adding the animation effect corresponding to the icon to the animated object.

9. The method according to claim 5, further comprising:
counting a video playing time; and
enlarging and displaying the facial image added with the effect in response to the counted time reaching a preset threshold.

10. An apparatus for adding a video effect, comprising:
a moving instruction obtaining unit configured to obtain a moving instruction;
a path determining unit configured to control a moving path of an animated object in a video frame based on the moving instruction;
an icon capturing unit configured to determine an icon captured by the animated object on the video frame based on the moving path; and
an effect adding unit configured to add the video effect corresponding to the icon to the video frame.

11. The apparatus according to claim 10, wherein the moving instruction obtaining unit comprises:
a posture obtaining subunit configured to obtain a posture of a control object; and
a moving instruction obtaining subunit configured to determine the corresponding moving instruction based on a correspondence between the posture and the moving instruction.

12. The apparatus according to claim 11, wherein the posture comprises a deflecting direction of a head of the control object; and
the moving instruction obtaining subunit is specifically configured to determine a moving direction of the animated object based on a correspondence between the deflecting direction of the head and the moving direction.

13. The apparatus according to claim 10, wherein,
the icon capturing unit is specifically configured to, based on the moving path, determine an icon to which a distance from the moving path is less than a preset distance as the icon captured by the animated object.

14. The apparatus according to claim 10, further comprising:
a facial image adding unit configured to obtain a facial image of the control object and display the facial image on the video frame, or configured to display a virtual facial image obtained based on processing of the facial image of the control object on the video frame, or configured to display a facial image of the animated object on the video frame,
wherein the effect adding unit is specifically configured to add the video effect corresponding to the icon to the facial image displayed on the video frame.

15. The apparatus according to claim 14, wherein the video effect corresponding to the icon comprises a makeup effect or a beauty effect; and
the effect adding unit is specifically configured to add the makeup effect or the beauty effect corresponding to the icon to the facial image.

16. The apparatus according to claim 15, wherein the effect adding unit, upon performing the operation of adding the makeup effect corresponding to the icon to the facial image, is specifically configured to:
upon the facial image already comprising the makeup effect corresponding to the icon, deepen a color of the makeup effect.

17. The apparatus according to claim 10, wherein the video effect corresponding to the icon comprises an animation effect of the animated object; and
the effect adding unit is specifically configured to add the animation effect corresponding to the icon to the animated object.

18. The apparatus according to claim 14, further comprising:
a time counting unit configured to count a video playing time; and
an enlarging display unit configured to enlarge and display the facial image added with the effect in response to the counted time reaching a preset threshold.

19. A terminal device, comprising:
a memory and a processor, wherein the memory stores a computer program; and the computer program, upon being executed by the processor, implements a method for adding a video effect, and the method comprises:
obtaining a moving instruction;
controlling a moving path of an animated object in a video frame based on the moving instruction;
determining an icon captured by the animated object on the video frame based on the moving path; and
adding the video effect corresponding to the icon to the video frame.

20. A computer-readable storage medium, which stores a computer program, wherein the computer program upon being executed by a processor, implements the method according to claim 1.

21. (canceled)
